(19) United States
(12) Patent Application Publication
(10) Pub. No.: US 2014/0003505 A1
(43) Pub. Date: Jan. 2, 2014

(54) METHOD AND APPARATUS FOR VIDEO CODING

(71) Applicants: Jani LAINEMA, Tampere (FI); Kemal UGUR, Istanbul (TR); Miska Matias HANNUKSELA, Tampere (FI); Mehmet Orguz BICI, Tampere (FI)

(72) Inventors: Jani LAINEMA, Tampere (FI); Kemal UGUR, Istanbul (TR); Miska Matias HANNUKSELA, Tampere (FI); Mehmet Orguz BICI, Tampere (FI)

(73) Assignee: NOKIA CORPORATION, Espoo (FI)

(21) Appl. No.: 13/928,829

(22) Filed: Jun. 27, 2013

Related U.S. Application Data
(60) Provisional application No. 61/667,352, filed on Jul. 2, 2012.

(51) Int. Cl. H04N 7/32

(52) U.S. Cl. CPC H04N 19/00569
USPC 375/240.12

(57) ABSTRACT

There is disclosed a method, apparatus and computer program product in which a block of a first layer of an image is obtaining for encoding. Also a block of a second layer of an image corresponding the block of the first layer is obtained. At least a first value is determined on the basis of samples of the block of the second layer and a prediction block for the block of the first layer is obtained. The first value is used to modify at least one value of the prediction block.

### TECHNICAL FIELD

The present application relates generally to an apparatus, a method and a computer program for video coding and decoding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

Scalable video coding refers to a coding structure where one bitstream can contain multiple representations of the content at different bitrates, resolutions, frame rates and/or other types of scalability. A scalable bitstream may consist of a base layer providing the lowest quality video available and one or more enhancement layers that enhance the video quality when received and decoded together with the lower layers. In order to improve coding efficiency for the enhancement layers, the coded representation of that layer may depend on the lower layers. Each layer together with all its dependent layers is one representation of the video signal at a certain spatial resolution, temporal resolution, quality level, and/or operation point of other types of scalability.

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

In the encoding of 3D video content, video compression systems, such as Advanced Video Coding standard H.264/AVC or the Multiview Video Coding MVC extension of H.264/AVC can be used.

### SUMMARY

Some embodiments proceed from the consideration that low frequency image components available from a base layer can be combined with high frequency prediction available from an enhancement layer and the combined signal can be utilized as a prediction for the enhancement layer samples. More generally, many embodiments utilize image components from one enhancement layer and use information obtained from the image components as a prediction for samples of another enhancement layer.

Various aspects of examples of the invention are provided in the detailed description.

According to a first aspect of the present invention, there is provided a method comprising:

obtaining a block of a first layer of an image for encoding;

obtaining a block of a second layer of an image corresponding the block of the first layer;

determining at least a first value on the basis of samples of the block of the second layer;

obtaining a prediction block for the block of the first layer; and

using the first value to modify at least one value of the prediction block.

According to a second aspect of the present invention, there is provided an apparatus comprising at least one processor and at least one memory including computer program code, the at least one memory and the computer program code configured to, with the at least one processor, cause the apparatus to:

obtain a block of a first layer of an image for encoding;

obtain a block of a second layer of an image corresponding the block of the first layer;

determine at least a first value on the basis of samples of the block of the second layer;

obtain a prediction block for the block of the first layer; and

use the first value to modify at least one value of the prediction block.

According to a third aspect of the present invention, there is provided a computer program product including one or more sequences of one or more instructions which, when executed by one or more processors, cause an apparatus to at least perform the following:

obtain a block of a first layer of an image for encoding;

obtain a block of a second layer of an image corresponding the block of the first layer;

determine at least a first value on the basis of samples of the block of the second layer;

obtain a prediction block for the block of the first layer; and

use the first value to modify at least one value of the prediction block.

According to a fourth aspect of the present invention, there is provided an apparatus comprising:

means for obtaining a block of a first layer of an image for encoding;

means for obtaining a block of a second layer of an image corresponding the block of the first layer;

means for determining at least a first value on the basis of samples of the block of the second layer;

means for obtaining a prediction block for the block of the first layer; and

means for using the first value to modify at least one value of the prediction block.

According to a fifth aspect of the present invention, there is provided a method comprising:

receiving a predicted block of a first layer of an image for decoding;

receiving a block of a second layer of an image corresponding the block of the first layer;

determining at least a first value on the basis of samples of the block of the second layer; and

using the first value to modify at least one value of the prediction block.

According to a sixth aspect of the present invention, there is provided an apparatus comprising at least one processor and at least one memory including computer program code, the at least one memory and the computer program code configured to, with the at least one processor, cause the apparatus to:

receive a predicted block of a first layer of an image for decoding;

receive a block of a second layer of an image corresponding the block of the first layer;

determine at least a first value on the basis of samples of the block of the second layer; and

use the first value to modify at least one value of the prediction block.

According to a seventh aspect of the present invention, there is provided a computer program product including one or more sequences of one or more instructions which, when executed by one or more processors, cause an apparatus to at least perform the following:

receive a predicted block of a first layer of an image for decoding;

receive a block of a second layer of an image corresponding the block of the first layer;

determine at least a first value on the basis of samples of the block of the second layer; and

use the first value to modify at least one value of the prediction block.

According to an eighth aspect of the present invention, there is provided an apparatus comprising:

means for receiving a predicted block of a first layer of an image for decoding;

means for receiving a block of a second layer of an image corresponding the block of the first layer;

means for determining at least a first value on the basis of samples of the block of the second layer; and

means for using the first value to modify at least one value of the prediction block.

### BRIEF DESCRIPTION OF THE DRAWINGS

For a more complete understanding of example embodiments of the present invention, reference is now made to the following descriptions taken in connection with the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4a shows schematically an embodiment of the invention as incorporated within an encoder;

FIG. 4b shows as a flow diagram an embodiment of encoding an enhancement layer block according to some embodiments of the invention;

FIG. 5a shows an example of modification of enhancement layer prediction samples on the basis of a DC value of base layer prediction samples; FIG. 5b depicts a situation in which the enhancement layer prediction samples of FIG. 5a have been adjusted by the DC value of the base layer prediction samples; FIG. 6a illustrates an example of a block 600 on an enhancement layer to be coded;

FIG. 6b illustrates an example of a transformed enhancement layer prediction block and an example of a transformed base layer block;

FIG. 6c illustrates the transformed enhancement layer prediction block in which a part of the coefficients have been replaced with some coefficients of the transformed base layer block;

FIG. 6d illustrates an inverse transformation of the modified transformed enhancement layer prediction block of FIG. 6c; and

FIG. 7 shows a schematic diagram of a decoder according to some embodiments of the invention.

### DETAILED DESCRIPTION OF SOME EXAMPLE EMBODIMENTS

In the following, several embodiments of the invention will be described in the context of one video coding arrangement. It is to be noted, however, that the invention is not limited to this particular arrangement. In fact, the different embodiments have applications widely in any environment where improvement of reference picture handling is required. For example, the invention may be applicable to video coding systems like streaming systems, DVD players, digital television receivers, personal video recorders, systems and computer programs on personal computers, handheld computers and communication devices, as well as network elements such as transcoders and cloud computing arrangements where video data is handled.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

There is a currently ongoing standardization project of High Efficiency Video Coding (HEVC) by the Joint Collaborative Team—Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In a draft HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can further be split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a HEVC WD5 is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD5, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD5, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

A syntax element may be defined as an element of data represented in the bitstream. A syntax structure may be defined as zero or more syntax elements present together in the bitstream in a specified order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit and whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5 bits) required to have a value equal to 1 in a draft HEVC standard. The temporal_id syntax element may be regarded as a temporal identifier for the NAL unit. The five-bit reserved field is expected to be used by extensions such as a future scalable and 3D video extension. It is expected that these five bits would carry information on the scalability hierarchy, such as quality_id or similar, dependency_id or similar, any other type of layer identifier, view order index or similar, view identifier, an identifier similar to priority_id of SVC indicating a valid sub-bitstream extraction if all NAL units greater than a specific identifier value are removed from the bitstream. Without loss of generality, in some example embodiments a variable LayerId is derived from the value of reserved_one_{—}5 bits for example as follows: LayerId=reserved_one_{—}5 bits−1.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU. In H.264/AVC and HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture or a CRA picture).

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. A picture parameter set contains such parameters that are likely to be unchanged in several coded pictures.

In a draft HEVC, there is also a third type of parameter sets, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. The NAL unit header indicates the type of the NAL unit and whether a coded slice contained in the NAL unit is a part of a reference picture or a non-reference picture.

Many hybrid video codecs, including H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may also be referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as a motion vector that indicates the position of the prediction block relative to the block being coded.

Inter prediction process may be characterized using one or more of the following factors.

The Accuracy of Motion Vector Representation.

For example, motion vectors may be of quarter-pixel accuracy, half-pixel accuracy or full-pixel accuracy and sample values in fractional-pixel positions may be obtained using a finite impulse response (FIR) filter.

Block Partitioning for Inter Prediction.

Many coding standards, including H.264/AVC and HEVC, allow selection of the size and shape of the block for which a motion vector is applied for motion-compensated prediction in the encoder, and indicating the selected size and shape in the bitstream so that decoders can reproduce the motion-compensated prediction done in the encoder.

Number of Reference Pictures for Inter Prediction.

The sources of inter prediction are previously decoded pictures. Many coding standards, including H.264/AVC and HEVC, enable storage of multiple reference pictures for inter prediction and selection of the used reference picture on a block basis. For example, reference pictures may be selected on macroblock or macroblock partition basis in H.264/AVC and on PU or CU basis in HEVC. Many coding standards, such as H.264/AVC and HEVC, include syntax structures in the bitstream that enable decoders to create one or more reference picture lists. A reference picture index to a reference picture list may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Motion Vector Prediction

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

Multi-Hypothesis Motion-Compensated Prediction

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Weighted Prediction

Many coding standards use a prediction weight of 1 for prediction blocks of inter (P) pictures and 0.5 for each prediction block of a B picture (resulting into averaging). H.264/AVC allows weighted prediction for both P and B slices. In implicit weighted prediction, the weights are proportional to picture order counts, while in explicit weighted prediction, prediction weights are explicitly indicated.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the TU (including e.g. DCT coefficient information). It may be signalled at CU level whether prediction error coding is applied or not for each CU. In the case there is no prediction error residual associated with the CU, it can be considered there are no TUs for the CU.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count (POC) difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in HEVC, a combined list (List C) is constructed after the final reference picture lists (List 0 and List 1) have been constructed. The combined list may be used for uni-prediction (also known as uni-directional prediction) within B slices.

A syntax structure for decoded reference picture marking may exist in a video coding system. For example, when the decoding of the picture has been completed, the decoded reference picture marking syntax structure, if present, may be used to adaptively mark pictures as “unused for reference” or “used for long-term reference”. If the decoded reference picture marking syntax structure is not present and the number of pictures marked as “used for reference” can no longer increase, a sliding window reference picture marking may be used, which basically marks the earliest (in decoding order) decoded reference picture as unused for reference.

Scalable video coding refers to a coding structure where one bitstream can contain multiple representations of the content at different bitrates, resolutions and/or frame rates. In these cases the receiver can extract the desired representation depending on its characteristics (e.g. resolution that matches best with the resolution of the display of the device). Alternatively, a server or a network element can extract the portions of the bitstream to be transmitted to the receiver depending on e.g. the network characteristics or processing capabilities of the receiver.

A scalable bitstream may consist of a base layer providing the lowest quality video available and one or more enhancement layers that enhance the video quality when received and decoded together with the lower layers. An enhancement layer may enhance the temporal resolution (i.e., the frame rate), the spatial resolution, or simply the quality of the video content represented by another layer or part thereof. In order to improve coding efficiency for the enhancement layers, the coded representation of that layer may depend on the lower layers. For example, the motion and mode information of the enhancement layer can be predicted from lower layers. Similarly the pixel data of the lower layers can be used to create prediction for the enhancement layer(s).

Each scalable layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_ref_base_pic_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL−1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_refactive_{—}1×_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

In an H.264/AVC bit stream, coded pictures in one coded video sequence uses the same sequence parameter set, and at any time instance during the decoding process, only one sequence parameter set is active. In SVC, coded pictures from different scalable layers may use different sequence parameter sets. If different sequence parameter sets are used, then, at any time instant during the decoding process, there may be more than one active sequence picture parameter set. In the SVC specification, the one for the top layer is denoted as the active sequence picture parameter set, while the rest are referred to as layer active sequence picture parameter sets. Any given active sequence parameter set remains unchanged throughout a coded video sequence in the layer in which the active sequence parameter set is referred to.

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded.

As indicated earlier, MVC is an extension of H.264/AVC. Many of the definitions, concepts, syntax structures, semantics, and decoding processes of H.264/AVC apply also to MVC as such or with certain generalizations or constraints. Some definitions, concepts, syntax structures, semantics, and decoding processes of MVC are described in the following.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit results in one decoded picture consisting of one or more decoded view components, when decoding errors, bitstream errors or other errors which may affect the decoding do not occur. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

In MVC, coded pictures from different views may use different sequence parameter sets. An SPS in MVC can contain the view dependency information for inter-view prediction. This may be used for example by signaling-aware media gateways to construct the view dependency tree.

In scalable multiview coding, the same bitstream may contain coded view components of multiple views and at least some coded view components may be coded using quality and/or spatial scalability.

A texture view refers to a view that represents ordinary video content, for example has been captured using an ordinary camera, and is usually suitable for rendering on a display. A texture view typically comprises pictures having three components, one luma component and two chroma components. In the following, a texture picture typically comprises all its component pictures or color components unless otherwise indicated for example with terms luma texture picture and chroma texture picture.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

A texture view component may be defined as a coded representation of the texture of a view in a single access unit. A texture view component in depth-enhanced video bitstream may be coded in a manner that is compatible with a single-view texture bitstream or a multi-view texture bitstream so that a single-view or multi-view decoder can decode the texture views even if it has no capability to decode depth views. For example, an H.264/AVC decoder may decode a single texture view from a depth-enhanced H.264/AVC bitstream. A texture view component may alternatively be coded in a manner that a decoder capable of single-view or multi-view texture decoding, such H.264/AVC or MVC decoder, is not able to decode the texture view component for example because it uses depth-based coding tools. A depth view component may be defined as a coded representation of the depth of a view in a single access unit. A view component pair may be defined as a texture view component and a depth view component of the same view within the same access unit.

Depth-enhanced video may be coded in a manner where texture and depth are coded independently of each other. For example, texture views may be coded as one MVC bitstream and depth views may be coded as another MVC bitstream. Depth-enhanced video may also be coded in a manner where texture and depth are jointly coded. When joint coding texture and depth views is applied for a depth-enhanced video representation, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture. In another option, coded video data of texture and coded video data of depth are not predicted from each other or one is not coded/decoded on the basis of the other one, but coded texture and depth view may be multiplexed into the same bitstream in the encoding and demultiplexed from the bitstream in the decoding. In yet another option, while coded video data of texture is not predicted from coded video data of depth in e.g. below slice layer, some of the high-level coding structures of texture views and depth views may be shared or predicted from each other. For example, a slice header of coded depth slice may be predicted from a slice header of a coded texture slice. Moreover, some of the parameter sets may be used by both coded texture views and coded depth views.

Depth-enhanced video formats enable generation of virtual views or pictures at camera positions that are not represented by any of the coded views. Generally, any depth-image-based rendering (DIBR) algorithm may be used for synthesizing views. Various DIBR methods have been proposed, some of which are briefly described in the following.

The DIBR techniques wherein a novel view is rendered from densely sampled views may be based on the so-called plenoptic function or its subsets. The plenoptic function was originally proposed as a 7D function to define the intensity of light rays passing through the camera center at every 3D location (3 parameters), at every possible viewing angle (2 parameters), for every wavelength, and at every time. If the time and the wavelength are known, the function simplifies into 5D function. The so-called light field system and Lumigraph system, in turn, represent objects in an outside-looking-in manner using a 4D subset of the plenoptic function.

However, DIBR techniques based on the plenoptic function may encounter a problem related to sampling theory. Based on sampling theory, minimum camera spacing density enabling to sample the plenoptic function densely enough to reconstruct the continuous function can be defined. Nevertheless, even the functions have been simplified in accordance with the minimum camera spacing density, enormous amount of data may still be required for storage. Theoretical approach may result in a camera array system with more than 100 cameras, which is impossible for most practical applications, due to limitation of camera size and storage capacity.

In contrast to the DIBR techniques more or less based on the plenoptic function, DIBR techniques related to image warping may be used to render a novel view from sparsely sampled views.

The 3D image warping techniques may conceptually construct a 3D point (named unprojection) and reproject it to a 2D image belonging to the new image plane. The whole system may have a number of views, while when interpolating a novel view, only one or more closest views may be used.

In 3D image warping, a perspective warp may be first used for small rotations in a scene. The perspective warp may compensate rotation but may not be sufficient to compensate translation, therefore depth of objects in the scene is considered. One approach is to divide a scene into multiple layers and each layer is independently rendered and warped. Then those warped layers may be composed to form the image for the novel view. Independent image layers may be composed in front-to-back manner. This approach may have a disadvantage that occlusion cycles may exist among three or more layers. An alternative solution is to resolve the composition with Z-buffering. It does not require the different layers to be non-overlapping.

Other warping techniques may employ explicit or implicit depth information (per-pixel), which thus can overcome certain restrictions, e.g., relating to translation. One can use e.g. pre-computed 3D warps, referred to as morph maps, which hold the per-pixel, image-space disparity motion vectors for a 3D warp of the associated reference image to the fiducial viewpoint. When generating a novel view, offset vectors in the direction specified by its morph-map entry is utilized to interpolate the depth value of the new pixel. If the reference image viewpoint and the fiducial viewpoint are close to each other, the linear approximation is good.

When pixels are mapped to the same pixel in the destination/target image, Z-buffering concept may be adopted to resolve the visibility. The offset vectors, which can also be referred to as disparity, are closely related to epipolar geometry, wherein the epipole of a second image is the projection of the center (viewpoint) of planar the second image to a first image.

In the case of depth-enhanced multiview coding, the view synthesis can be utilized in an encoding loop of the encoder and in the decoding loop of the decoder, thus providing a view synthesis prediction (VSP). A view synthesis picture (a reference component) may be synthesized from coded texture views and depth views and may contain samples that may be used for the view synthesis prediction. To enable view synthesis prediction for the coding of the current view, the previously coded texture and depth view components of the same access unit may be used for the view synthesis. Such a view synthesis that uses the previously coded texture and depth view components of the same access unit may be referred to as a forward view synthesis or forward-projected view synthesis, and similarly view synthesis prediction using such view synthesis may be referred to as forward view synthesis prediction or forward-projected view synthesis prediction.

A view synthesis picture may also be referred to as synthetic reference component, which may be defined to contain samples that may be used for view synthesis prediction. A synthetic reference component may be used as reference picture for view synthesis prediction but is typically not output or displayed. A view synthesis picture is typically generated for the same camera location assuming the same camera parameters as for the picture being coded or decoded.

A view-synthesized picture may be introduced in the reference picture list in a similar way as is done with inter-view reference pictures. Signaling and operations with reference picture list in the case of view synthesis prediction may remain identical or similar to those specified in H.264/AVC or HEVC. Processes for predicting from view synthesis reference picture, such as motion information derivation, may remain identical or similar to processes specified for inter, inter-layer, and inter-view prediction of H.264/AVC or HEVC. Alternatively or in addition, specific coding modes for the view synthesis prediction may be specified and signaled by the encoder in the bitstream. For example, in a VSP skip/direct mode the motion vector difference (de)coding and the (de)coding of the residual prediction error for example using transform-based coding may also be omitted. For example, if a macroblock may be indicated within the bitstream to be coded using a skip/direct mode, it may further be indicated within the bitstream whether a VSP frame is used as reference. Alternatively or in addition, view-synthesized reference blocks, rather than or in addition to complete view synthesis reference pictures, may be generated by the encoder and/or the decoder and used as prediction reference for various prediction processes.

Many video encoders utilize the Lagrangian cost function to find rate-distortion optimal coding modes, for example the desired macroblock mode and associated motion vectors. This type of cost function uses a weighting factor or λ (lambda) to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

A coding standard may include a sub-bitstream extraction process, and such is specified for example in SVC, MVC, and HEVC. The sub-bitstream extraction process relates to converting a bitstream by removing NAL units to a sub-bitstream. The sub-bitstream still remains conforming to the standard. For example, in a draft HEVC standard, the bitstream created by excluding all VCL NAL units having a temporal_id greater than or equal to a selected value and including all other VCL NAL units remains conforming. Consequently, a picture having temporal_id equal to TID does not use any picture having a temporal_id greater than TID as inter prediction reference.

In the following an example embodiment of coding a block of pixels in an enhancement layer (an enhancement layer block) is described in more detail. The block of pixels to be coded may also be called as a current block.

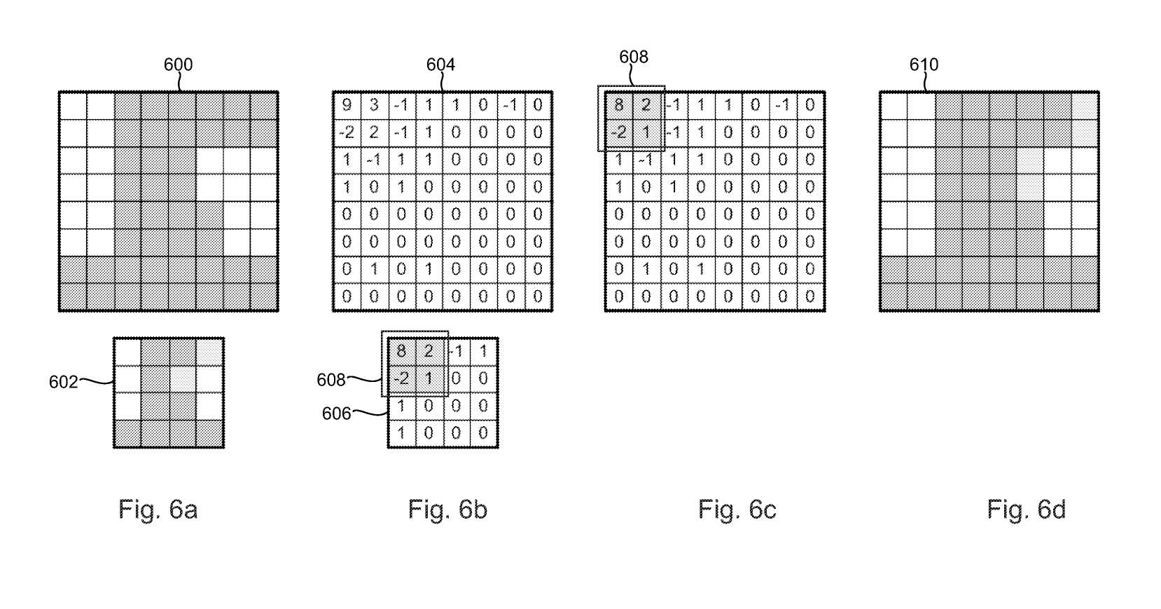

When the encoder is encoding the current block a block of pixels in the base layer corresponding to the enhancement layer block is searched or otherwise identified or determined using heuristic rules. The search method of the heuristic rules may depend on the type of scalability between the base layer and the enhancement layer. For example, if quality scalability is applied between the base and enhancement layer, a heuristic rule may be that the base layer block spatially co-locates with the enhancement layer block. In another example, one view of a multiview bitstream is considered the base layer and another view of the multiview bitstream is considered the enhancement layer. The base layer block may be identified for example using motion estimation, for which the search window to comprise only horizontal displacement as in many multiview arrangements cameras are parallel and may be rectified. The encoder may indicate the displacement using a motion vector or motion vector difference in the bitstream to the decoder. In multiview-video-plus-depth coding, the displacement may be concluded by the encoder and the decoder from a depth or disparity view or picture corresponding to the base layer and/or enhancement layer of the texture. The corresponding block on the base layer need not have the same size than the current block but may also be smaller or larger. FIG. 6a illustrates an example of a block 600 on an enhancement layer to be coded i.e. the block 600 is an example of the current block. The block 602 in FIG. 6a illustrates the corresponding block in the base layer. In this example the spatial scalability ratio between the first enhancement layer and the base layer is 2:1 i.e. one pixel in the block 602 of the base layer can be represented with four pixels (in a 2×2 matrix) in the first enhancement layer. However, the scalability ratio may be different from 2:1.

In some embodiments the number of enhancement layers may be one, two or more than two wherein the enhancement layer in which the block to be coded/decoded exists, may be a first enhancement layer, a second enhancement layer or another enhancement layer if it exists.

In some embodiments the corresponding block in the base layer may be determined by calculating the coordinates and dimensions of the base layer block 602 based on the coordinates of the enhancement layer block 600 and a known scaling parameter. For example, the coordinates and size of the enhancement layer block 600 may be divided by the scaling parameter. In the case of 2:1 spatial scalability the scaling parameter would be 2.

On the basis of the corresponding block 602 of the base layer a DC value 500, e.g. an average of sample values of the corresponding block 602 is calculated or determined otherwise. Instead of the average value other mathematical operation(s) may be used to obtain the DC value. In some embodiments obtaining the DC value can be performed by applying a two-dimensional (2D) spatial transform, such as a discrete Cosine Transform or its derivatives, and identifying the DC component resulting from the transform.

A prediction operation such as a spatial (intra) or temporal (motion compensated) prediction is performed for the current block to obtain a predicted enhancement layer block. The prediction may include e.g. applying intra or inter prediction tools defined by the H.265/HEVC standard.

When the predicted enhancement layer block is available and the DC value has been determined on the basis of the corresponding base layer block, the predicted enhancement layer block may be modified e.g. so that the DC component of the enhancement layer prediction block is substituted with the DC value. This can be done in various ways. For example, both the DC value 500 for the base layer block DC(b) and the DC value 502 of the enhancement layer block DC(e) can be calculated and the predicted sample values P(x,y) generated in the prediction operation can be updated by adding the difference of the DC values DC(delta)=DC(b)−DC(e) to the samples: P(x,y)+DC(delta).

In some embodiments the adding may include some kind of limiting operation to prevent the value P(x,y) exceeding a certain value range. An example of such limiting operation is a clip operation:

P(x,y)=Clip(P(x,y)+DC(delta))

The clip operation clips the updated sample prediction values to a selected nominal range (e.g. [0, 255] in the case of 8-bit sample processing).

In some other implementations the limiting operation can be omitted.

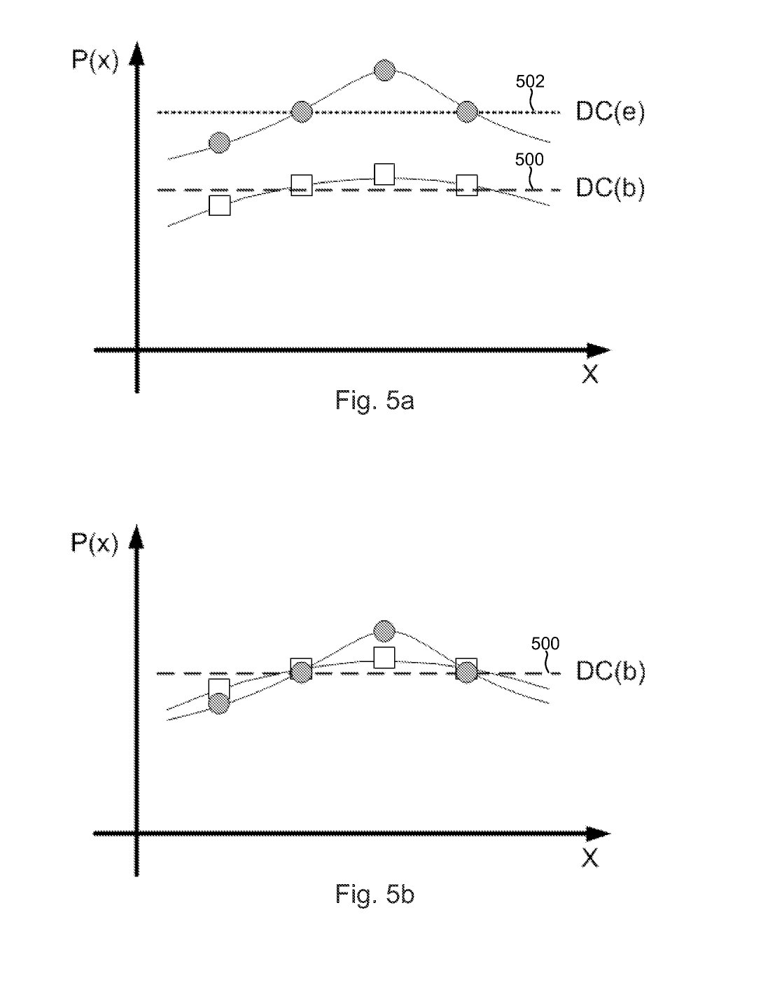

FIGS. 5a and 5b illustrate the update process for a one dimensional data set.

FIG. 5a illustrates an example of modification of enhancement layer prediction samples on the basis of DC value of base layer prediction samples. The base layer prediction samples are depicted with squares and the enhancement layer prediction samples are depicted with circles. The base layer prediction samples may have been upsampled to obtain the same amount of samples than the enhancement layer. In the figure the DC value DC(b) of the base layer prediction samples is depicted with the dotted line 500 and the DC value DC(e) of the enhancement layer prediction samples is depicted with the other dotted line 502.

FIG. 5b depicts a situation in which the enhancement layer prediction samples of FIG. 5a have been adjusted by the DC value DC(b) of the base layer prediction samples of FIG. 5a so that the DC value of the adjusted enhancement layer prediction samples is aligned with the DC value of the base layer prediction samples.

Another alternative for implementing the modification of the predicted enhancement layer block is to perform forward 2D spatial transforms for both the base layer block and the initial enhancement layer prediction block generated by the prediction operation and possibly scaling one or both of the results to align the gains of potentially different sized transforms. Now the DC substitution can be done in the frequency domain setting the DC coefficient of the enhancement layer block to have the value of the DC of the base layer block, followed by inverse transform to obtain the updated enhancement layer prediction block. In this implementation the inverse transform can further be delayed and the residual signal can be added to the prediction signal in the transformed domain, followed by an inverse transform returning the joint signal to the spatial domain.

Another alternative for implementing the base-layer-based DC value modification to the enhancement layer is as follows. The generation of enhancement layer prediction block is performed conventionally without taking the base layer into account. An initial prediction error block is then generated for the enhancement layer block for example by subtracting the enhancement layer prediction block from the original block and transforming the resulting block with DCT or alike transform to transform domain. The DC value (from the base layer block) can then be subtracted from the DC coefficient of this transformed prediction error block. This modified prediction error block can then be quantized and entropy-coded for example using processes used conventionally e.g. in H.264/AVC or HEVC. In this alternative implementation, the size and shape of the base layer block may be determined on the basis of the transform unit or block of the enhancement layer rather than the prediction unit of the enhancement layer.

In various embodiments, instead of or in addition to the DC value, any transformed component can be processed in the similar manner. For example, the lowest 2×2 transform coefficients from base layer can be used to substitute the 2×2 lowest transform coefficients of the enhancement layer prediction signal as illustrated in FIGS. 6b to 6d.

In FIG. 6b the block 604 illustrates the transformed enhancement layer prediction block and the block 606 illustrates the transformed base layer block. A smaller block is selected from the transformed base layer block representing the DC value and a few low frequency values. In this example the selected block is of the size 2×2 as is indicated with the square 608. The corresponding values of the enhancement layer prediction block are then replaced with the values of the selected block, as is illustrated in FIG. 6c. In this example, the 2×2 lowest frequency coefficients of the transformed enhancement layer prediction block has been substituted with 2×2 lowest frequency coefficients of the transformed base layer block.

The modified transformed enhancement layer prediction block is inverse transformed to obtain the modified enhancement layer prediction block 610, as is illustrated in FIG. 6d.

It should be noted that the size of the substitution block need not be 2×2 but also other sizes may be used, e.g. 3×3, 4×4 or larger.

When the inverse transformed enhancement layer prediction block 610 has been obtained possible residual signal may be identified and coded/decoded. The residual signal represents a difference between the original image block and the enhancement layer prediction block (e prediction error). The reconstructed residual signal may then be added to the enhancement layer prediction block to obtain a reconstructed enhancement layer block.

The encoding/decoding of the prediction error may be performed in various ways. For example, prediction error coding methods of the H.265/HEVC standard may be applied.

The encoded base layer prediction block and/or the enhancement layer prediction block and the prediction error may be decoded by a decoder using corresponding methods than in the encoding but partly in a reversed order.

Although the embodiments above described that the base layer prediction block is used to form the enhancement layer prediction block it is also possible to correspondingly use a block in one enhancement layer to modify a block in a higher or lower enhancement layer.

In some embodiments it is also possible to weight different transform coefficients differently. For example, the DC component of the updated enhancement layer prediction signal can be formed by a weighted average of the DC coefficient of the base layer block and the DC coefficient of the original enhancement layer prediction block. The weighting can be signaled in the coded representation, can be predetermined or can be derived from other information, such as the quantization parameters of the different layers or analyzing the content of the base layer and enhancement layer prediction blocks.

In some embodiments, the encoder uses always any of the presented implementation options. In some embodiments, the encoder may be configured to use any of the presented implementation options or not to use any of them for example on sequence or picture basis. In some implementations, the encoder makes a decision e.g. on block basis whether any of the presented implementation options is used or e.g. conventional coding is used, for example based on a cost function, such as rate-distortion optimization, or heuristic rules. In some embodiments, the encoder may analyze the sequence and determine the use of any of the presented implementation options based on such analysis. For example, the encoder may use a subset of luma samples of a base layer picture and a temporal/inter reference picture for the enhancement layer to determine an average illumination level or average luma value for each of these pictures. If the average illumination level differs significantly, such as exceeds a pre-defined threshold value, the encoder may decide to use any of the presented implementation options.

The decision whether or not to mix the base layer component to the enhancement layer prediction can be signaled by various means or it can be based on other information (e.g. analyzing the content of the base layer prediction block and the enhancement layer prediction block or the size of the prediction block or prediction mode of an intra prediction or the temporal prediction information such as whether bi-prediction or uni-prediction is used for the associated enhancement layer prediction block).

The video can be scalably coded with more than two enhancement layers. In this case, the DC or other frequency components of an enhancement layer can be determined based on a subset of the previously coded enhancement and base layers or a combination of those.

The above described methods can be applied to any video coding schemes that include coding of more than one video stream where some of the streams are coded depending on other streams, such as stereo or multi-view video coding. In this case, in order to apply the described method, a dependent view can use the referenced view's picture or a reference picture generated using a depth based algorithm such as view synthesis prediction as the base layer from which the DC or other frequency components are to be replaced with.

It may also be possible to select a larger or a smaller region in the base layer to calculate DC or other frequency components. The different size region selection can be performed by including or excluding a number of boundary pixels. Another alternative is that a subset of the pixels in the base layer can be considered by downsampling or subsampling by a given factor.

If the base layer resolution is smaller than enhancement layer resolution, then the region in the base layer may be upsampled by an upsampling method with possible filtering such that the regions has the same resolution as the current prediction block in the enhancement layer. Then the DC value or other frequency components of the upsampled region may be considered in the modification (substitution) process.

The above described methods of substituting the DC component of the enhancement layer prediction block can be applied in different phases of the coding/decoding process, i.e. it is not limited for only prediction samples. For example, it can also be applied for the reconstructed samples after adding quantized residual to the inverse transformed coefficients. Similarly, it can be applied after a deblocking process. It can be applied after a post-processing process that adds offsets to reconstructed samples such as the Sample Adaptive Offset method in HEVC. It can also be applied after a post-processing filtering process such that Adaptive Loop Filter in HEVC.

For the implementation described for processing in the transform/frequency domain, transforms other than DCT can be used. An alternative transform is discrete sine transform (DST) or its derivatives. In this case, similar to DCT, a subset of the DST coefficients in the enhancement layer is to be replaced with those of the base layer.

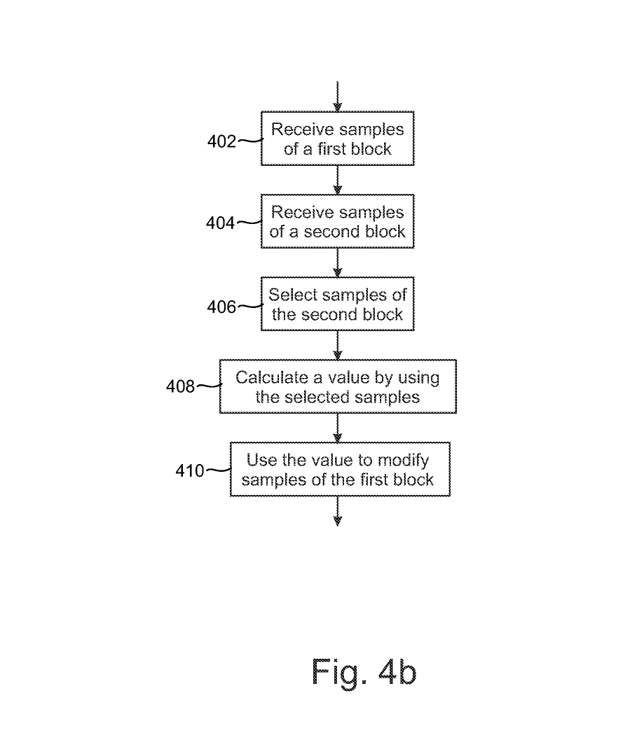

FIG. 4a shows a block diagram for video encoding and decoding according to an example embodiment.

FIG. 4a shows the encoder as comprising a pixel predictor 302, prediction error encoder 303 and prediction error decoder 304. FIG. 4a also shows an embodiment of the pixel predictor 302 as comprising an inter-predictor 306, an intra-predictor 308, a mode selector 310, a filter 316, and a reference frame memory 318. In this embodiment the mode selector 310 comprises a block processor 381 and a cost evaluator 382. The encoder may further comprise an entropy encoder 330 for entropy encoding the bit stream.

The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of a current frame or picture). The output of both the inter-predictor and the intra-predictor are passed to the mode selector 310. Both the inter-predictor 306 and the intra-predictor 308 may have more than one intra-prediction modes. Hence, the inter-prediction and the intra-prediction may be performed for each mode and the predicted signal may be provided to the mode selector 310. The mode selector 310 also receives a copy of the image 300.

The mode selector 310 determines which encoding mode to use to encode the current block. If the mode selector 310 decides to use an inter-prediction mode it will pass the output of the inter-predictor 306 to the output of the mode selector 310. If the mode selector 310 decides to use an intra-prediction mode it will pass the output of one of the intra-predictor modes to the output of the mode selector 310.

The mode selector 310 may use, in the cost evaluator block 382, for example Lagrangian cost functions to choose between coding modes and their parameter values, such as motion vectors, reference indexes, and intra prediction direction, typically on block basis. This kind of cost function may use a weighting factor lambda to tie together the (exact or estimated) image distortion due to lossy coding methods and the (exact or estimated) amount of information that is required to represent the pixel values in an image area: C=D+lambda×R, where C is the Lagrangian cost to be minimized, D is the image distortion (e.g. Mean Squared Error) with the mode and their parameters, and R the number of bits needed to represent the required data to reconstruct the image block in the decoder (e.g. including the amount of data to represent the candidate motion vectors).

The output of the mode selector is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the future image 300 is compared in inter-prediction operations. In many embodiments the reference frame memory 318 may be capable of storing more than one decoded picture, and one or more of them may be used by the inter-predictor 306 as reference pictures against which the future images 300 are compared in inter prediction operations. The reference frame memory 318 may in some cases be also referred to as the Decoded Picture Buffer.

The operation of the pixel predictor 302 may be configured to carry out any known pixel prediction algorithm known in the art.

The pixel predictor 302 may also comprise a filter 385 to filter the predicted values before outputting them from the pixel predictor 302.

The prediction error encoder 303 comprises a transform block 342 and a quantizer 344. The transform block 342 transforms the first prediction error signal 320 to a transform domain. The transform is, for example, the DCT transform or its variant. The quantizer 344 quantizes the transform domain signal, e.g. the DCT coefficients, to form quantized coefficients.

The prediction error decoder 304 receives the output from the prediction error encoder 303 and produces a decoded prediction error signal 338 which when combined with the prediction representation of the image block 312 at the second summing device 339 produces the preliminary reconstructed image 314. The prediction error decoder may be considered to comprise a dequantizer 346, which dequantizes the quantized coefficient values, e.g. DCT coefficients, to reconstruct the transform signal approximately and an inverse transformation block 348, which performs the inverse transformation to the reconstructed transform signal wherein the output of the inverse transformation block 348 contains reconstructed block(s). The prediction error decoder may also comprise a macroblock filter (not shown) which may filter the reconstructed macroblock according to further decoded information and filter parameters.

FIG. 4b depicts as a flow diagram an embodiment of the operation of the block processor 381 in encoding an enhancement layer block according to an example embodiment. The block processor 381 receives 402 samples of the base layer block and a prediction of the enhancement layer block. The block processor 381 determines 404 which sample or samples of the base layer block to use in the process and calculates 406 the DC value or other coefficients by using the samples of the base layer block. The block processor 381 generates 408 or receives from the inter-predictor 306 or from the intra-predictor 308 the prediction for the enhancement layer block and uses 410 the DC value or other coefficients to modify a part of the enhancement layer prediction block values. The prediction error is also determined 412 and added 414 to the enhancement layer prediction block.

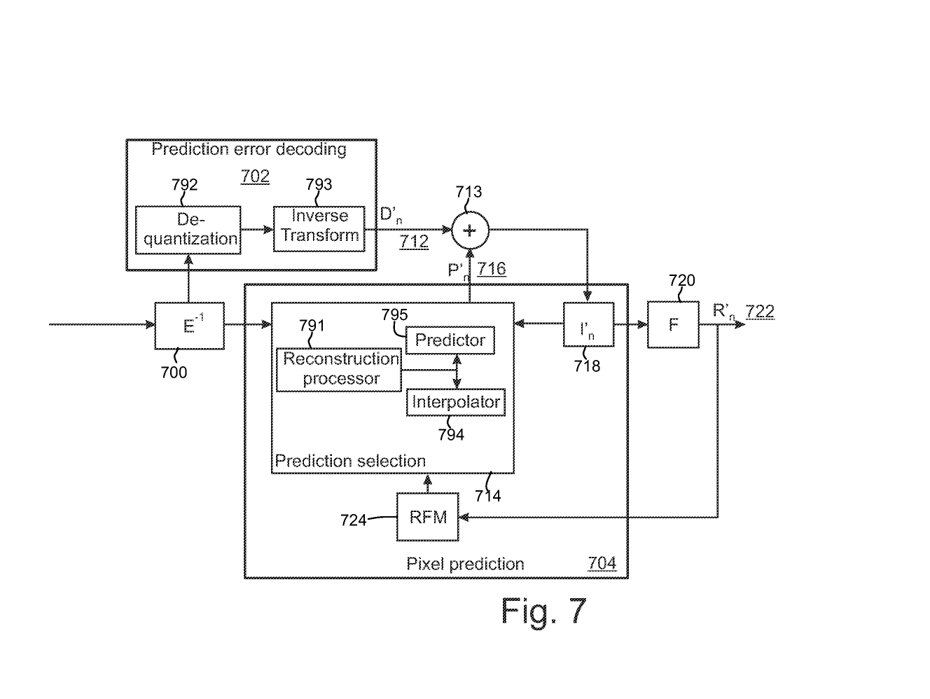

In the following the operation of an example embodiment of the decoder 700 is depicted in more detail with reference to FIG. 7.

For completeness a suitable decoder is hereafter described. At the decoder side similar operations are performed to reconstruct the image blocks. FIG. 7 shows a block diagram of a video decoder suitable for employing embodiments of the invention. The decoder shows an entropy decoder 700 which performs an entropy decoding on the received signal. The entropy decoder thus performs the inverse operation to the entropy encoder 330 of the encoder described above. The entropy decoder 700 outputs the results of the entropy decoding to a prediction error decoder 702 and pixel predictor 704.

The pixel predictor 704 receives the output of the entropy decoder 700. The output of the entropy decoder 700 may include an indication on the prediction mode used in encoding the current block. A predictor selector 714 within the pixel predictor 704 may determine that the current block to be decoded is an enhancement layer block. Hence, the predictor selector 714 may select to use information from a corresponding block on another layer such as the base layer to modify the enhancement layer prediction block while decoding the current block. An indication that the modified enhancement layer prediction block has been used by the encoder may have been received by the decoder wherein the reconstruction processor 791 may use the indication to switch to the modified decoding mode, or the decoder may comprise a parameter which indicates the reconstruction processor 791 to use the modified decoding mode, or there may be other ways to determine whether or not the modified decoding mode should be used. The decoder may also be provided with an indication which value or values to use in the modified decoding mode, or the reconstruction processor 791 may determine in the corresponding way than the encoder the value or values for the modified decoding process and how to use these values i.e. if a DC value should be calculated and used in the substitution of some (decoded) sample values of the enhancement layer predicted block.

The predictor selector may output a predicted representation of an image block 716 to a first combiner 713. The predicted representation of the image block 716 is used in conjunction with the reconstructed prediction error signal 712 to generate a preliminary reconstructed image 718. The preliminary reconstructed image 718 may be used in the predictor 714 or may be passed to a filter 720. The filter 720 applies a filtering which outputs a final reconstructed signal 722. The final reconstructed signal 722 may be stored in a reference frame memory 724, the reference frame memory 724 further being connected to the predictor 714 for prediction operations.

The prediction error decoder 702 receives the output of the entropy decoder 700. A dequantizer 792 of the prediction error decoder 702 may dequantize the output of the entropy decoder 700 and the inverse transform block 793 may perform an inverse transform operation to the dequantized signal output by the dequantizer 792. The output of the entropy decoder 700 may also indicate that prediction error signal is not to be applied and in this case the prediction error decoder produces an all zero output signal.

In some example embodiments the decoding a block of pixels may comprise the following. An enhancement layer (an enhancement layer block) is used as a non-limiting example of the first layer (the first layer block) and a base layer is used as a non-limiting example of the second layer (the second layer block). The block of pixels to be decoded may also be called as a current block.

In some embodiments the decoder may receive an indication that the enhancement layer block has been partly modified in the encoding process by using information of the base layer block. In such embodiments the decoder may decode the indication and on the basis of the indication may determine whether to use in the decoding process information on the base block to modify an enhancement layer block which is to be decoded.

In some other embodiments the decoder may determine from other sources of information whether to use in the decoding process information on the base block to modify an enhancement layer block which is to be decoded. The other information may be the content of the base layer prediction block and the enhancement layer prediction block or the size of the prediction block or prediction mode of an intra prediction or the temporal prediction information such as whether bi-prediction or uni-prediction has been used for the associated enhancement layer prediction block.

If the decoder has determined that information on the base block has been used in the encoding of the current block, the decoder may select to perform the decoding process by modifying the enhancement layer block which is to be decoded.

It is assumed that the decoder has decoded the corresponding base layer block from which information for the modification may be used by the decoder. The current block of pixels in the base layer corresponding to the enhancement layer block may be searched by the decoder or the decoder may receive and decode information from the bitstream indicative of the base block and/or which information of the base block to use in the modification process. As was disclosed above in connection with the encoding process, the search method of the heuristic rules may depend on the type of scalability between the base layer and the enhancement layer. For example, if quality scalability is applied between the base and enhancement layer, a heuristic rule may be that the base layer block spatially co-locates with the enhancement layer block. In another example, one view of a multiview bitstream is considered the base layer and another view of the multiview bitstream is considered the enhancement layer. The base layer block may be identified for example using motion estimation, for which the search window to comprise only horizontal displacement as in many multiview arrangements cameras are parallel and may be rectified. The decoder may receive in the bitstream from the encoder an indication of the displacement e.g. as a motion vector or motion vector difference. In multiview-video-plus-depth coding, the displacement may be concluded by the encoder and the decoder from a depth or disparity view or picture corresponding to the base layer and/or enhancement layer of the texture.

On the basis of the corresponding block of the base layer a DC value, e.g. an average of sample values of the corresponding block is calculated by the decoder or determined otherwise. Instead of the average value other mathematical operation(s) may be used to obtain the DC value. In some embodiments obtaining the DC value can be performed by applying a two-dimensional (2D) spatial transform, such as a discrete Cosine Transform or its derivatives, and identifying the DC component resulting from the transform.

A prediction operation such as a spatial (intra) or temporal (motion compensated) prediction is performed for the current block to obtain a reconstructed enhancement layer prediction block. The prediction may include e.g. applying intra or inter prediction tools defined by the H.265/HEVC standard.

When the reconstructed enhancement layer prediction block is available and the DC value has been determined on the basis of the corresponding base layer block, the reconstructed enhancement layer prediction block may be modified e.g. so that the DC component of the enhancement layer prediction block is substituted with the DC value. This can be done in various ways. For example, both the DC value for the base layer block DC(b) and the DC value of the enhancement layer block DC(e) can be calculated and the predicted sample values P(x,y) generated in the prediction operation can be updated by adding the difference of the DC values DC(delta)=DC(b)−DC(e) to the samples: P(x,y)+DC(delta).

In some embodiments the adding may include some kind of limiting operation to prevent the value P(x,y) exceeding a certain value range. An example of such limiting operation is a clip operation presented in connection with the encoding process.

In some other implementations the limiting operation can be omitted.

The possibly reconstructed residual signal may then be added to the reconstructed enhancement layer prediction block to obtain a reconstructed enhancement layer block.

In the decoding process the alternative implementations described above in connection with the encoding process may also be used for the modification of the reconstructed enhancement layer prediction block. For example, it is possible to perform forward 2D spatial transforms for both the base layer block and the initial reconstructed enhancement layer prediction block generated by the prediction operation and possibly scaling one or both of the results to align the gains of potentially different sized transforms. Now the DC substitution can be done in the frequency domain setting the DC coefficient of the enhancement layer block to have the value of the DC of the base layer block, followed by inverse transform to obtain the updated reconstructed enhancement layer prediction block. In this implementation the inverse transform can further be delayed and the residual signal can be added to the prediction signal in the transformed domain, followed by an inverse transform returning the joint signal to the spatial domain.

Another alternative for implementing the base-layer-based DC value modification to the enhancement layer is as follows. The generation of the reconstructed enhancement layer prediction block is performed conventionally without taking the base layer into account. An initial prediction error block is then generated for the reconstructed enhancement layer block for example by subtracting the reconstructed enhancement layer prediction block from the original block and transforming the resulting block with DCT or alike transform to transform domain. The DC value (from the base layer block) can then be subtracted from the DC coefficient of this transformed prediction error block. This modified reconstructed prediction error block can then be used to form the reconstructed enhancement layer block. In this alternative implementation, the size and shape of the base layer block may be determined on the basis of the transform unit or block of the enhancement layer rather than the prediction unit of the enhancement layer.

As described above, an access unit may contain slices of different component types (e.g. primary texture component, redundant texture component, auxiliary component, depth/disparity component), of different views, and of different scalable layers. A component picture may be defined as a collective term for a dependency representation, a layer representation, a texture view component, a depth view component, a depth map, or anything like. Coded component pictures may be separated from each other using a component picture delimiter NAL unit, which may also carry common syntax element values to be used for decoding of the coded slices of the component picture. An access unit can consist of a relatively large number of component pictures, such as coded texture and depth view components as well as dependency and layer representations. The coded size of some component pictures may be relatively small for example because they can be considered to represent deltas relative to base view or base layer and because depth component pictures may be relatively easy to compress. When component picture delimiter NAL units are present in the bitstream, a component picture may be defined as a component picture delimiter NAL unit and the subsequent coded slice NAL units until the end of the access unit or until the next component picture delimiter NAL unit, exclusive, whichever is earlier in decoding order.

Inter-component prediction may be defined to comprise prediction of syntax element values, sample values, variable values used in the decoding process, or anything alike from a component picture of one type to a component picture of another type. For example, inter-component prediction may comprise prediction of a texture view component from a depth view component, or vice versa.

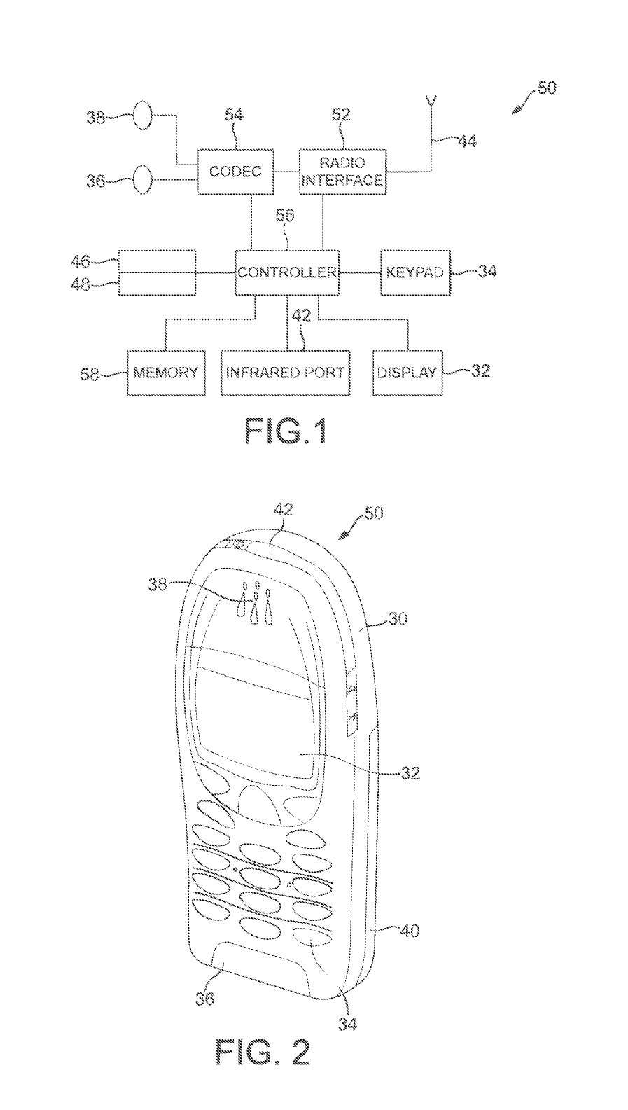

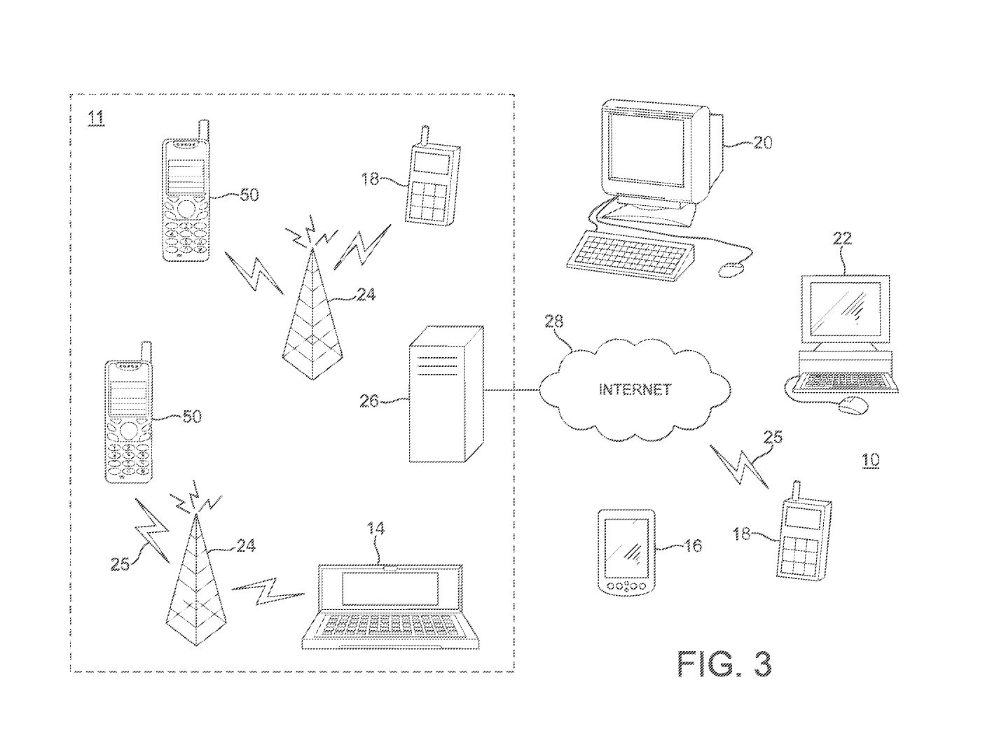

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

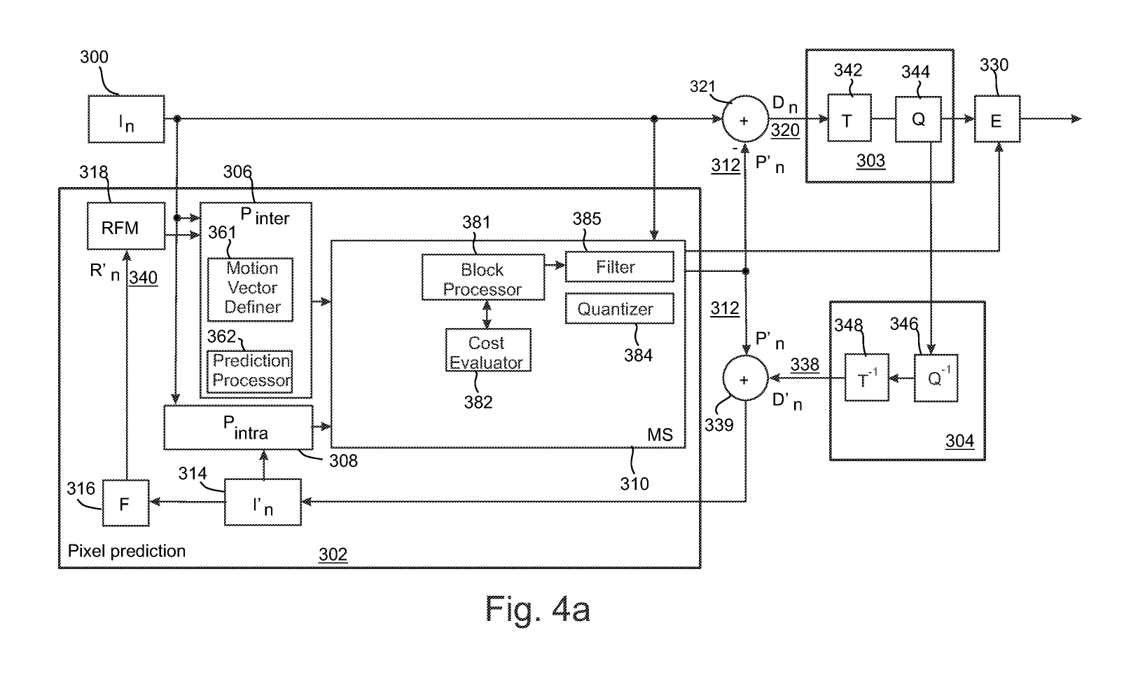

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

In the above, some embodiments have been described in relation to coding/decoding methods or tools having inter-component dependency, such as inter-layer coding/decoding or prediction tools. It needs to be understood that embodiments may not be specific to the described coding/decoding methods but could be realized with any similar coding/decoding methods or tools.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys Inc., of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example there is provided a method comprising:

obtaining a block of a first layer of an image for encoding;

obtaining a block of a second layer of an image corresponding the block of the first layer;

determining at least a first value on the basis of samples of the block of the second layer;

obtaining a prediction block for the block of the first layer; and

using the first value to modify at least one value of the prediction block.

In some embodiments the first layer is an enhancement layer of a scalable video; and the second layer is a base layer of the scalable video.

In some embodiments the first value is a DC value of sample values of the block of the second layer.

In some embodiments the first value is a weighted average of sample values of the block of the second layer.

In some embodiments obtaining a prediction block for the block of the first layer comprises using intra prediction.

In some embodiments obtaining a prediction block for the block of the first layer comprises using motion compensated prediction.

In some embodiments the first layer is one of the views of a multiview video; and the second layer is another view of the multiview video.

In some embodiments modification of the prediction block comprises determining an offset and adding the offset to each pixel value.

In some embodiments the modification comprises:

calculating a first DC value of sample values of the block of the first layer;

calculating a second DC value of sample values of the block of the second layer;

adding the difference of the second DC value and the first DC value to predicted sample values of the block of the first layer.

In some embodiments the adding comprises limiting the values resulting from the adding within a certain value range.

In some embodiments the method comprises:

transforming the block of the second layer to obtain transform coefficients of the block of the second layer representative of different frequency components of sample values of the block of the second layer;

obtaining transform coefficients of the block of the first layer representative of different frequency components of sample values of the block of the first layer; and

replacing one or more of the lowest frequency components of the first layer with one or more lowest frequency components of the second layer.

In some embodiments the first value is subtracted from the values of the prediction block.

In some embodiments the determining comprises determining a set of values; and using the set of values to modify the prediction block.

In some embodiments the set of values comprises values representing lowest frequency information of the image.

In some embodiments the values in the set of values are obtained by using a different weighting factor for each value in the set.

In some embodiments the prediction block is modified by transforming the prediction block replacing a part of the values of the transformed prediction block with the set of values and inverse transforming the prediction block.

In some embodiments the method comprises deciding whether or not to modify the prediction block.

In some embodiments the deciding comprises examining at least one of the following:

analyzing the content of the blocks of the first layer and the second layer;

examining the size of the prediction block;

examining the prediction mode used in the prediction of the block of the first layer;

examining whether bi-prediction or uni-prediction is used for the prediction of the block of the first layer.

In some embodiments the size of the block of the first layer is the same than the size of the block of the first layer.

In some embodiments the size of the block of the second layer is the different than the size of the block of the first layer.

In some embodiments the block of the second layer is scaled to correspond with the size of the block of the first layer.

In some embodiments the use of the modification is signaled in a bitstream.

According to a second example there is provided an apparatus comprising at least one processor and at least one memory including computer program code, the at least one memory and the computer program code configured to, with the at least one processor, cause the apparatus to:

obtain a block of a first layer of an image for encoding;

obtain a block of a second layer of an image corresponding the block of the first layer;

determine at least a first value on the basis of samples of the block of the second layer;

obtain a prediction block for the block of the first layer; and

use the first value to modify at least one value of the prediction block

In some embodiments of the apparatus the first layer is an enhancement layer of a scalable video; and the second layer is a base layer of the scalable video.

In some embodiments of the apparatus the first value is a DC value of sample values of the block of the second layer.

In some embodiments of the apparatus the first value is a weighted average of sample values of the block of the second layer.

In some embodiments of the apparatus said at least one memory stored with code thereon, which when executed by said at least one processor, further causes the apparatus to obtain a prediction block for the block of the first layer by using intra prediction.

In some embodiments of the apparatus said at least one memory stored with code thereon, which when executed by said at least one processor, further causes the apparatus to obtain a prediction block for the block of the first layer by using motion compensated prediction.

In some embodiments of the apparatus said at least one memory stored with code thereon, which when executed by said at least one processor, further causes the apparatus to use one of the views of a multiview video as the first layer; and to use another view of the multiview video as the second layer.

In some embodiments of the apparatus said at least one memory stored with code thereon, which when executed by said at least one processor, further causes the apparatus to modify the prediction block by determining an offset and adding the offset to each pixel value.

In some embodiments of the apparatus said at least one memory stored with code thereon, which when executed by said at least one processor, further causes the apparatus to:

calculate a first DC value of sample values of the block of the first layer;

calculate a second DC value of sample values of the block of the second layer;

add the difference of the second DC value and the first DC value to predicted sample values of the block of the first layer.

In some embodiments of the apparatus said at least one memory stored with code thereon, which when executed by said at least one processor, further causes the apparatus to limit the values resulting from the adding within a certain value range.

In some embodiments of the apparatus said at least one memory stored with code thereon, which when executed by said at least one processor, further causes the apparatus to:

transform the block of the second layer to obtain transform coefficients of the block of the second layer representative of different frequency components of sample values of the block of the second layer;

obtain transform coefficients of the block of the first layer representative of different frequency components of sample values of the block of the first layer; and

replace one or more of the lowest frequency components of the first layer with one or more lowest frequency components of the second layer.

In some embodiments of the apparatus said at least one memory stored with code thereon, which when executed by said at least one processor, further causes the apparatus to subtract the first value from the values of the prediction block.

In some embodiments of the apparatus said at least one memory stored with code thereon, which when executed by said at least one processor, further causes the apparatus to determine a set of values; and to use the set of values to modify the prediction block.

In some embodiments of the apparatus the set of values comprises values representing lowest frequency information of the image.

In some embodiments of the apparatus said at least one memory stored with code thereon, which when executed by said at least one processor, further causes the apparatus to obtain the values in the set of values by using a different weighting factor for each value in the set.

In some embodiments of the apparatus said at least one memory stored with code thereon, which when executed by said at least one processor, further causes the apparatus to modify the prediction block by replacing a part of the values of the prediction block with the set of values.

In some embodiments of the apparatus said at least one memory stored with code thereon, which when executed by said at least one processor, further causes the apparatus to decide whether or not to modify the prediction block.

In some embodiments of the apparatus said at least one memory stored with code thereon, which when executed by said at least one processor, further causes the apparatus to decide whether or not to modify the prediction block by examining at least one of the following:

analyzing the content of the blocks of the first layer and the second layer;

examining the size of the prediction block;

examining the prediction mode used in the prediction of the block of the first layer;

examining whether bi-prediction or uni-prediction is used for the prediction of the block of the first layer.

In some embodiments of the apparatus the size of the block of the first layer is the same than the size of the block of the first layer.

In some embodiments of the apparatus the size of the block of the second layer is the different than the size of the block of the first layer.

In some embodiments of the apparatus said at least one memory stored with code thereon, which when executed by said at least one processor, further causes the apparatus to scale the block of the second layer to correspond with the size of the block of the first layer.

In some embodiments of the apparatus said at least one memory stored with code thereon, which when executed by said at least one processor, further causes the apparatus to signal the use of the modification in a bitstream.

According to a third example there is provided a computer program product including one or more sequences of one or more instructions which, when executed by one or more processors, cause an apparatus to at least perform the following:

obtain a block of a first layer of an image for encoding;

obtain a block of a second layer of an image corresponding the block of the first layer;

determine at least a first value on the basis of samples of the block of the second layer;

obtain a prediction block for the block of the first layer; and

use the first value to modify at least one value of the prediction block

In some embodiments of the computer program product the first layer is an enhancement layer of a scalable video; and the second layer is a base layer of the scalable video.

In some embodiments of the computer program product the first value is a DC value of sample values of the block of the second layer.

In some embodiments of the computer program product the first value is a weighted average of sample values of the block of the second layer.

In some embodiments the computer program product includes one or more sequences of one or more instructions which, when executed by one or more processors, cause the apparatus to obtain a prediction block for the block of the first layer by using intra prediction.

In some embodiments the computer program product includes one or more sequences of one or more instructions which, when executed by one or more processors, cause the apparatus to obtain a prediction block for the block of the first layer by using motion compensated prediction.

In some embodiments the computer program product includes one or more sequences of one or more instructions which, when executed by one or more processors, cause the apparatus to use one of the views of a multiview video as the first layer; and to use another view of the multiview video as the second layer.

In some embodiments the computer program product includes one or more sequences of one or more instructions which, when executed by one or more processors, cause the apparatus to modify the prediction block by determining an offset and adding the offset to each pixel value.

In some embodiments the computer program product includes one or more sequences of one or more instructions which, when executed by one or more processors, cause the apparatus to:

calculate a first DC value of sample values of the block of the first layer;

calculate a second DC value of sample values of the block of the second layer;

add the difference of the second DC value and the first DC value to predicted sample values of the block of the first layer.

In some embodiments the computer program product includes one or more sequences of one or more instructions which, when executed by one or more processors, cause the apparatus to limit the values resulting from the adding within a certain value range.

In some embodiments the computer program product includes one or more sequences of one or more instructions which, when executed by one or more processors, cause the apparatus to:

transform the block of the second layer to obtain transform coefficients of the block of the second layer representative of different frequency components of sample values of the block of the second layer;

obtain transform coefficients of the block of the first layer representative of different frequency components of sample values of the block of the first layer; and

replace one or more of the lowest frequency components of the first layer with one or more lowest frequency components of the second layer.

In some embodiments the computer program product includes one or more sequences of one or more instructions which, when executed by one or more processors, cause the apparatus to subtract the first value from the values of the prediction block.

In some embodiments the computer program product includes one or more sequences of one or more instructions which, when executed by one or more processors, cause the apparatus to determine a set of values; and to use the set of values to modify the prediction block.

In some embodiments of the computer program product the set of values comprises values representing lowest frequency information of the image.

In some embodiments the computer program product includes one or more sequences of one or more instructions which, when executed by one or more processors, cause the apparatus to obtain the values in the set of values by using a different weighting factor for each value in the set.

In some embodiments the computer program product includes one or more sequences of one or more instructions which, when executed by one or more processors, cause the apparatus to modify the prediction block by replacing a part of the values of the prediction block with the set of values.

In some embodiments the computer program product includes one or more sequences of one or more instructions which, when executed by one or more processors, cause the apparatus to decide whether or not to modify the prediction block.

In some embodiments the computer program product includes one or more sequences of one or more instructions which, when executed by one or more processors, cause the apparatus to decide whether or not to modify the prediction block by examining at least one of the following:

analyzing the content of the blocks of the first layer and the second layer;

examining the size of the prediction block;

examining the prediction mode used in the prediction of the block of the first layer; examining whether bi-prediction or uni-prediction is used for the prediction of the block of the first layer.

In some embodiments of the computer program product the size of the block of the first layer is the same than the size of the block of the first layer.

In some embodiments of the computer program product the size of the block of the second layer is the different than the size of the block of the first layer.

In some embodiments the computer program product includes one or more sequences of one or more instructions which, when executed by one or more processors, cause the apparatus to scale the block of the second layer to correspond with the size of the block of the first layer.

In some embodiments the computer program product includes one or more sequences of one or more instructions which, when executed by one or more processors, cause the apparatus to signal the use of the modification in a bitstream.

According to a fourth example there is provided an apparatus comprising:

means for obtaining a block of a first layer of an image for encoding;

means for obtaining a block of a second layer of an image corresponding the block of the first layer;

means for determining at least a first value on the basis of samples of the block of the second layer;

means for obtaining a prediction block for the block of the first layer; and

means for using the first value to modify at least one value of the prediction block

According to a fifth example there is provided a method comprising:

receiving a predicted block of a first layer of an image for decoding;

receiving a block of a second layer of an image corresponding the block of the first layer;

determining at least a first value on the basis of samples of the block of the second layer; and

using the first value to modify at least one value of the prediction block.

In some embodiments of the method the first layer is an enhancement layer of a scalable video; and the second layer is a base layer of the scalable video.

In some embodiments of the method the first value is a DC value of sample values of the block of the second layer.

In some embodiments of the method the first value is a weighted average of sample values of the block of the second layer.

In some embodiments the method comprises obtaining a prediction block for the block of the first layer comprises using intra prediction.

In some embodiments the method comprises obtaining a prediction block for the block of the first layer comprises using motion compensated prediction.

In some embodiments the method comprises using one of the views of a multiview video as the first layer; and using another view of the multiview video as the second layer.

In some embodiments of the method the modification of the prediction block comprising determining an offset and adding the offset to each pixel value.

In some embodiments the method comprises:

calculating a first DC value of sample values of the block of the first layer;

calculating a second DC value of sample values of the block of the second layer;

adding the difference of the second DC value and the first DC value to predicted sample values of the block of the first layer.

In some embodiments of the method the adding comprises limiting the values resulting from the adding within a certain value range.

In some embodiments the method comprises:

transforming the block of the second layer to obtain transform coefficients of the block of the second layer representative of different frequency components of sample values of the block of the second layer;

obtaining transform coefficients of the block of the first layer representative of different frequency components of sample values of the block of the first layer; and

replacing one or more of the lowest frequency components of the first layer with one or more lowest frequency components of the second layer.

In some embodiments the method comprises subtracting the first value from the values of the prediction block.

In some embodiments of the method the determining comprises determining a set of values; and using the set of values to modify the prediction block.

In some embodiments of the method the set of values comprises values representing lowest frequency information of the image.

In some embodiments the method comprises obtaining the values in the set of values by using a different weighting factor for each value in the set.

In some embodiments the method comprises modifying the prediction block by replacing a part of the values of the prediction block with the set of values.

In some embodiments the method comprises deciding whether or not to modify the prediction block.

In some embodiments of the method the deciding comprises examining at least one of the following:

analyzing the content of the blocks of the first layer and the second layer;

examining the size of the prediction block;

examining the prediction mode used in the prediction of the block of the first layer;

examining whether bi-prediction or uni-prediction is used for the prediction of the block of the first layer.

In some embodiments of the method the size of the block of the first layer is the same than the size of the block of the first layer.

In some embodiments of the method the size of the block of the second layer is the different than the size of the block of the first layer.

In some embodiments the method comprises scaling the block of the second layer to correspond with the size of the block of the first layer.

In some embodiments the method comprises receiving information on the use of the modification from a bitstream.

According to a sixth example there is provided an apparatus comprising at least one processor and at least one memory including computer program code, the at least one memory and the computer program code configured to, with the at least one processor, cause the apparatus to:

receive a predicted block of a first layer of an image for decoding;

receive a block of a second layer of an image corresponding the block of the first layer;

determine at least a first value on the basis of samples of the block of the second layer; and

use the first value to modify at least one value of the prediction block.

In some embodiments of the apparatus the first layer is an enhancement layer of a scalable video; and the second layer is a base layer of the scalable video.

In some embodiments of the apparatus the first value is a DC value of sample values of the block of the second layer.

In some embodiments of the apparatus the first value is a weighted average of sample values of the block of the second layer.

In some embodiments of the apparatus said at least one memory stored with code thereon, which when executed by said at least one processor, further causes the apparatus to obtain a prediction block for the block of the first layer by using intra prediction.

In some embodiments of the apparatus said at least one memory stored with code thereon, which when executed by said at least one processor, further causes the apparatus to obtain a prediction block for the block of the first layer by using motion compensated prediction.

In some embodiments of the apparatus said at least one memory stored with code thereon, which when executed by said at least one processor, further causes the apparatus to use one of the views of a multiview video as the first layer; and to use another view of the multiview video as the second layer.

In some embodiments of the apparatus said at least one memory stored with code thereon, which when executed by said at least one processor, further causes the apparatus to modify the prediction block by determining an offset and adding the offset to each pixel value.

In some embodiments of the apparatus said at least one memory stored with code thereon, which when executed by said at least one processor, further causes the apparatus to:

calculate a first DC value of sample values of the block of the first layer;

calculate a second DC value of sample values of the block of the second layer;

add the difference of the second DC value and the first DC value to predicted sample values of the block of the first layer.

In some embodiments of the apparatus said at least one memory stored with code thereon, which when executed by said at least one processor, further causes the apparatus to limit the values resulting from the adding within a certain value range.

In some embodiments of the apparatus said at least one memory stored with code thereon, which when executed by said at least one processor, further causes the apparatus to:

transform the block of the second layer to obtain transform coefficients of the block of the second layer representative of different frequency components of sample values of the block of the second layer;

obtain transform coefficients of the block of the first layer representative of different frequency components of sample values of the block of the first layer; and

replace one or more of the lowest frequency components of the first layer with one or more lowest frequency components of the second layer.

In some embodiments of the apparatus said at least one memory stored with code thereon, which when executed by said at least one processor, further causes the apparatus to subtract the first value from the values of the prediction block.

In some embodiments of the apparatus said at least one memory stored with code thereon, which when executed by said at least one processor, further causes the apparatus to determine a set of values; and to use the set of values to modify the prediction block.

In some embodiments of the apparatus the set of values comprises values representing lowest frequency information of the image.

In some embodiments of the apparatus said at least one memory stored with code thereon, which when executed by said at least one processor, further causes the apparatus to obtain the values in the set of values by using a different weighting factor for each value in the set.

In some embodiments of the apparatus said at least one memory stored with code thereon, which when executed by said at least one processor, further causes the apparatus to modify the prediction block by replacing a part of the values of the prediction block with the set of values.

In some embodiments of the apparatus said at least one memory stored with code thereon, which when executed by said at least one processor, further causes the apparatus to decide whether or not to modify the prediction block.

In some embodiments of the apparatus said at least one memory stored with code thereon, which when executed by said at least one processor, further causes the apparatus to decide whether or not to modify the prediction block by examining at least one of the following:

analyzing the content of the blocks of the first layer and the second layer;

examining the size of the prediction block;

examining the prediction mode used in the prediction of the block of the first layer;

examining whether bi-prediction or uni-prediction is used for the prediction of the block of the first layer.

In some embodiments of the apparatus the size of the block of the first layer is the same than the size of the block of the first layer.

In some embodiments of the apparatus the size of the block of the second layer is the different than the size of the block of the first layer.

In some embodiments of the apparatus said at least one memory stored with code thereon, which when executed by said at least one processor, further causes the apparatus to scale the block of the second layer to correspond with the size of the block of the first layer.

In some embodiments of the apparatus said at least one memory stored with code thereon, which when executed by said at least one processor, further causes the apparatus to receive an indication of the use of the modification from a bitstream.

According to a seventh example there is provided a computer program product including one or more sequences of one or more instructions which, when executed by one or more processors, cause an apparatus to at least perform the following:

receive a predicted block of a first layer of an image for decoding;

receive a block of a second layer of an image corresponding the block of the first layer;

determine at least a first value on the basis of samples of the block of the second layer; and

use the first value to modify at least one value of the prediction block.

In some embodiments of the computer program product the first layer is an enhancement layer of a scalable video; and the second layer is a base layer of the scalable video.

In some embodiments of the computer program product the first value is a DG value of sample values of the block of the second layer.

In some embodiments of the computer program product the first value is a weighted average of sample values of the block of the second layer.

In some embodiments the computer program product includes one or more sequences of one or more instructions which, when executed by one or more processors, cause the apparatus to obtain a prediction block for the block of the first layer by using intra prediction.

In some embodiments the computer program product includes one or more sequences of one or more instructions which, when executed by one or more processors, cause the apparatus to obtain a prediction block for the block of the first layer by using motion compensated prediction.

In some embodiments the computer program product includes one or more sequences of one or more instructions which, when executed by one or more processors, cause the apparatus to use one of the views of a multiview video as the first layer; and to use another view of the multiview video as the second layer.

In some embodiments the computer program product includes one or more sequences of one or more instructions which, when executed by one or more processors, cause the apparatus to modify the prediction block by determining an offset and adding the offset to each pixel value.

In some embodiments the computer program product includes one or more sequences of one or more instructions which, when executed by one or more processors, cause the apparatus to:

calculate a first DC value of sample values of the block of the first layer;

calculate a second DC value of sample values of the block of the second layer;

add the difference of the second DC value and the first DC value to predicted sample values of the block of the first layer.

In some embodiments the computer program product includes one or more sequences of one or more instructions which, when executed by one or more processors, cause the apparatus to limit the values resulting from the adding within a certain value range.

In some embodiments the computer program product includes one or more sequences of one or more instructions which, when executed by one or more processors, cause the apparatus to:

transform the block of the second layer to obtain transform coefficients of the block of the second layer representative of different frequency components of sample values of the block of the second layer;

obtain transform coefficients of the block of the first layer representative of different frequency components of sample values of the block of the first layer; and

replace one or more of the lowest frequency components of the first layer with one or more lowest frequency components of the second layer.

In some embodiments the computer program product includes one or more sequences of one or more instructions which, when executed by one or more processors, cause the apparatus to subtract the first value from the values of the prediction block.

In some embodiments the computer program product includes one or more sequences of one or more instructions which, when executed by one or more processors, cause the apparatus to determine a set of values; and to use the set of values to modify the prediction block.

In some embodiments of the computer program product the set of values comprises values representing lowest frequency information of the image.

In some embodiments the computer program product includes one or more sequences of one or more instructions which, when executed by one or more processors, cause the apparatus to obtain the values in the set of values by using a different weighting factor for each value in the set.

In some embodiments the computer program product includes one or more sequences of one or more instructions which, when executed by one or more processors, cause the apparatus to modify the prediction block by replacing a part of the values of the prediction block with the set of values.

In some embodiments the computer program product includes one or more sequences of one or more instructions which, when executed by one or more processors, cause the apparatus to decide whether or not to modify the prediction block.

In some embodiments the computer program product includes one or more sequences of one or more instructions which, when executed by one or more processors, cause the apparatus to decide whether or not to modify the prediction block by examining at least one of the following:

analyzing the content of the blocks of the first layer and the second layer;

examining the size of the prediction block;

examining the prediction mode used in the prediction of the block of the first layer;

examining whether bi-prediction or uni-prediction is used for the prediction of the block of the first layer.

In some embodiments of the computer program product the size of the block of the first layer is the same than the size of the block of the first layer.

In some embodiments of the computer program product the size of the block of the second layer is the different than the size of the block of the first layer.

In some embodiments the computer program product includes one or more sequences of one or more instructions which, when executed by one or more processors, cause the apparatus to scale the block of the second layer to correspond with the size of the block of the first layer.

In some embodiments the computer program product includes one or more sequences of one or more instructions which, when executed by one or more processors, cause the apparatus to receive an indication on the use of the modification from a bitstream.

According to an eighth example there is provided an apparatus comprising:

means for receiving a predicted block of a first layer of an image for decoding;

means for receiving a block of a second layer of an image corresponding the block of the first layer;

means for determining at least a first value on the basis of samples of the block of the second layer; and

means for using the first value to modify at least one value of the prediction block.

What is claimed is:

1. A method comprising:
obtaining a predicted block of a first layer of an image;
obtaining a block of a second layer of an image corresponding the block of the first layer;
determining at least a first value on the basis of samples of the block of the second layer; and
using the first value to modify at least one value of the predicted block.

2. The method according to claim 1, wherein the first layer is an enhancement layer of a scalable video; and the second layer is a base layer of the scalable video.

3. The method according to claim 1, wherein the first value is at least one of the following:
a DC value of sample values of the block of the second layer;
a weighted average of sample values of the block of the second layer.

4. The method according to claim 1 comprising using one of the views of a multiview video as the first layer; and using another view of the multiview video as the second layer.

5. The method according to claim 1, the modification of the prediction block comprising determining an offset and adding the offset to each pixel value.

6. The method according to claim 1 comprising:
calculating a first DC value of sample values of the block of the first layer;
calculating a second DC value of sample values of the block of the second layer;
adding the difference of the second DC value and the first DC value to predicted sample values of the block of the first layer.

7. The method according to claim 1 comprising:
transforming the block of the second layer to obtain transform coefficients of the block of the second layer representative of different frequency components of sample values of the block of the second layer;
obtaining transform coefficients of the block of the first layer representative of different frequency components of sample values of the block of the first layer; and
modifying one or more of the lowest frequency components of the first layer using one or more lowest frequency components of the second layer.

8. The method according to claim 1, further comprising deciding whether or not to modify the prediction block by examining at least one of the following:
analyzing the content of the blocks of the first layer and the second layer;
examining the size of the prediction block;
examining the prediction mode used in the prediction of the block of the first layer;
examining whether bi-prediction or uni-prediction is used for the prediction of the block of the first layer;
examining whether information on the use of the modification is indicated in a bitstream.

9. An apparatus comprising at least one processor and at least one memory including computer program code, the at least one memory and the computer program code configured to, with the at least one processor, cause the apparatus to:
obtain a predicted block of a first layer of an image;
obtain a block of a second layer of an image corresponding the block of the first layer;
determine at least a first value on the basis of samples of the block of the second layer; and
use the first value to modify at least one value of the predicted block.

10. The apparatus according to claim 9, wherein the first layer is an enhancement layer of a scalable video; and the second layer is a base layer of the scalable video.

11. The apparatus according to claim 9, wherein the first value is at least one of the following:
a DC value of sample values of the block of the second layer;
a weighted average of sample values of the block of the second layer.

12. The apparatus according to claim 9, said at least one memory stored with code thereon, which when executed by said at least one processor, further causes the apparatus to use one of the views of a multiview video as the first layer; and to use another view of the multiview video as the second layer.

13. The apparatus according to claim 9, said at least one memory stored with code thereon, which when executed by said at least one processor, further causes the apparatus to modify the prediction block by determining an offset and adding the offset to each pixel value.

14. The apparatus according to claim 9, said at least one memory stored with code thereon, which when executed by said at least one processor, further causes the apparatus to:
calculate a first DC value of sample values of the block of the first layer;
calculate a second DC value of sample values of the block of the second layer;
add the difference of the second DC value and the first DC value to predicted sample values of the block of the first layer.

15. The apparatus according to claim 9, said at least one memory stored with code thereon, which when executed by said at least one processor, further causes the apparatus to:
transform the block of the second layer to obtain transform coefficients of the block of the second layer representative of different frequency components of sample values of the block of the second layer;
obtain transform coefficients of the block of the first layer representative of different frequency components of sample values of the block of the first layer; and
modify one or more of the lowest frequency components of the first layer with one or more lowest frequency components of the second layer.

16. The apparatus according to claim 9, said at least one memory stored with code thereon, which when executed by said at least one processor, further causes the apparatus to decide whether or not to modify the prediction block by examining at least one of the following:
analyzing the content of the blocks of the first layer and the second layer;
examining the size of the prediction block;
examining the prediction mode used in the prediction of the block of the first layer;
examining whether bi-prediction or uni-prediction is used for the prediction of the block of the first layer;
examining whether information on the use of the modification is indicated in a bitstream.
